(19) United States
(12) Patent Application Publication
(10) Pub. No.: US 2002/0143729 A1
(43) Pub. Date: Oct. 3, 2002

(54) Portable assistant

(76) Inventor: Gideon Fostick, Givat Shmuel (IL)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/820,221

(22) Filed: Mar. 29, 2001

(51) Int. Cl. G06F 7/00

(52) U.S. Cl. 707/1

(57) ABSTRACT

The present invention is of a system for advising and instructing a user performing an activity such as golfing. Using the system, such relevant information as geographical and topographical information, meteorological information and information concerning the skill of the user in the activity are combined with the user's present location information by a processor to yield a suggested strategy that is presented to the user by a display system, such as a cellular telephone or a personal digital assistant.

### FIELD AND BACKGROUND OF THE INVENTION

The present invention relates to the field of information systems, and more specifically to decision support systems.

Many human activities involve decision-making. The relative success of an individual in such an activity is dependent on the quality of decisions made. A person who consistently performs better than average is often called an expert. Being an expert requires natural talent, but no less important is the ability to make the optimal decision. The steps of decision-making involve concentrating the salient data which has influence on the decision, evaluating it properly, choosing the most appropriate tool from those available and choosing the manner of using the tool. Thereafter, tool quality and physical skill determine the success of the decided action.

To improve the overall performance of the activity, performance of each step should be optimized. Practice can improve performance on a purely mechanical level. The use of better tools is also an important method to improve performance. The combination of practice and the use of an instructor helps a person improve data gathering, data evaluation and tool selection skills.

In some fields of human endeavor, the data influencing a decision is relatively limited. For instance, the game of billiards takes place in an environment closely approaching ideal Newtonian conditions. Tool choice is limited to different lengths and weights of the cue, both of which can be compensated for by player skill. Thus, once the basics of Newtonian mechanics are mastered, billiards is a game of physical skill.

In contrast, a sport such as golf is highly influenced by external factors. The most basic variable is golf-course topology, that is, distances and golf-course terrain as well as the location of obstacles. Secondly, meteorological conditions have a strong influence on performance. Wind conditions, temperature and rain are the most important factors. In addition, terrain-dependent local meteorological conditions, such as winds influenced by groves of trees can influence game performance. Gathering this data, especially for a non-expert golfer playing at an unfamiliar golf-course is a highly difficult task. Once gathered, this data must be properly analyzed to ensure selection of the correct golf club, and to choose with what geometry and force the ball must be struck.

A novice golfer spends a significant amount of time practicing to gradually improve data gathering and data analysis skills. An alternative is to hire an expert, such as a golf-pro, who accompanies the novice and helps the novice make decisions, thereby accelerating the novice's rate of learning, and increasing the pleasure the novice experiences by reducing or eliminating critically wrong decisions.

The disadvantage of hiring a golf-pro is that it is rather expensive and sometimes socially unacceptable. Often a highly skilled golf-pro is unavailable or does not adequately speak the language of the player. Hiring a golf-pro may also require an investment of time which the player would prefer not to commit, for instance when playing an ad hoc game of golf on an unfamiliar golf-course. Furthermore, decisions often need to be based on knowledge of the abilities and experience of the player. A non-dedicated golf-pro lacks this knowledge and thus the advice given may often be of a general nature and not specific for the individual player.

There is therefore a clear and long-felt need for a system which can assist in the performance of certain human activities, such as playing golf, which can gather and evaluate conditions and, based on the individual history of the user, advise the proper course of action when performing the complex activity.

### SUMMARY OF THE INVENTION

The above and other objectives are achieved by the innovative system and method provided by the present invention.

According to the present invention, there is provided a system for advising and instructing a user performing an activity, the system comprising: a) a first database with geographical and topographical data salient to performance of the activity; b) a locating mechanism for determining the location of the user; and c) a processor to consult the first database and the locating mechanism and, based on the data and the location, to recommend a course of action to the user.

According to a further feature of the invention, the system also includes a meteorological reporting mechanism for gathering meteorological data salient to performance of the activity, and the processor includes the meteorological data when formulating the recommended course of action.

According to a further feature of the invention, the system also includes a second database with historical data salient to performance of the activity by the user, and the processor also consults the second database when formulating a recommended course of action.

According to a further feature of the invention, the system also includes a display unit to display the recommended course of action to the user. The display unit can be portable and configured to accompany the user during performance of the activity and can be, for example, a cellular telephone or a personal digital assistant.

According to another feature of the invention, the locating mechanism includes a satellite positioning system receiver.

According to another feature of the invention, the locating mechanism includes a tracer configured to accompany the user during performance of the activity and to transmit a signal, and a plurality of receivers located at disparate respective geographical locations are configured to receive the signal. The tracer can be, for example, a cellular telephone or be integrated into a personal digital assistant.

According to another feature of the present invention the locating mechanism includes a tracer configured to accompany the user during performance of the activity and to receive signals, and a plurality of transmitters located at disparate respective geographical locations are configured to transmit signals.

According to a further aspect of the invention, the processor calculates the position based on the characteristics of the received signals or a second processor is employed for this task.

According to a still further aspect of the invention, the system if configured to advise a strategy or course of action concerning how to proceed in a sport, such as golf.

There is also provided according to the teachings of the present invention a method of improving a user's performance in a sport, the method including: a) electronically storing geographical and topographical data salient to performance of the sport; b) determining the physical location of the user; and c) recommending a course of action, based on the geographical and topographical data, the historical data and the user's physical location.

According to a further aspect of the invention, the method additionally includes supplying meteorological data salient to performance of the sport, and the recommended course of action is also based on this meteorological data.

According to a further aspect of invention, the method includes electronically storing historical data salient to performance of the sport by the user, and the recommended course of action is also based on the historical data.

According to yet a further aspect of the invention, the recommended course of action involves selection of a golf club and/or a golfing stroke.

### BRIEF DESCRIPTION OF THE DRAWINGS

The invention is herein described, by way of example only, with reference to the accompanying drawings, wherein:

FIG. 1. is a block diagram of the elements of the system of the invention; and

FIG. 2. is a flowchart showing the operation of the processor according to one non-limiting example of the invention.

### DETAILED DESCRIPTION OF THE PREFERRED EMBODIMENT

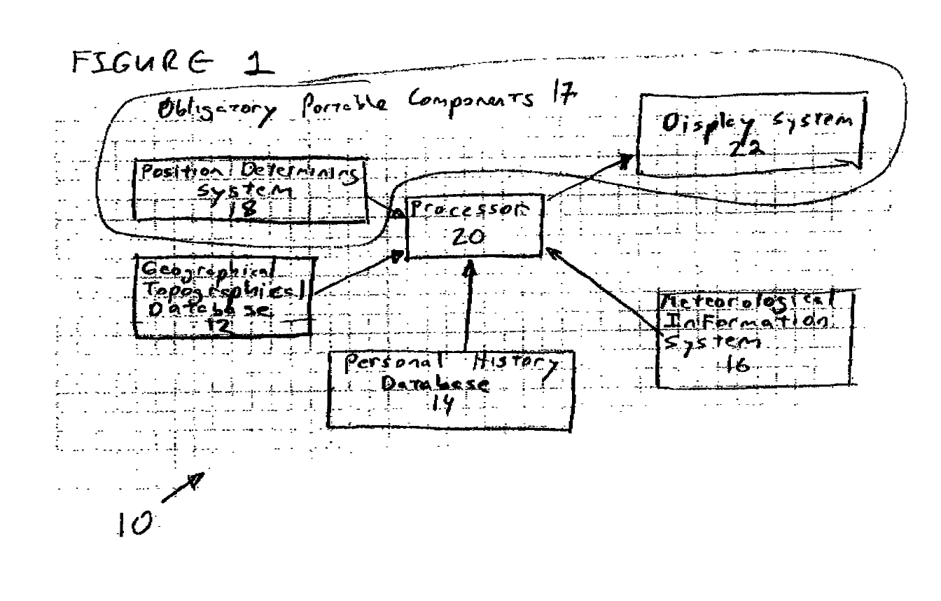

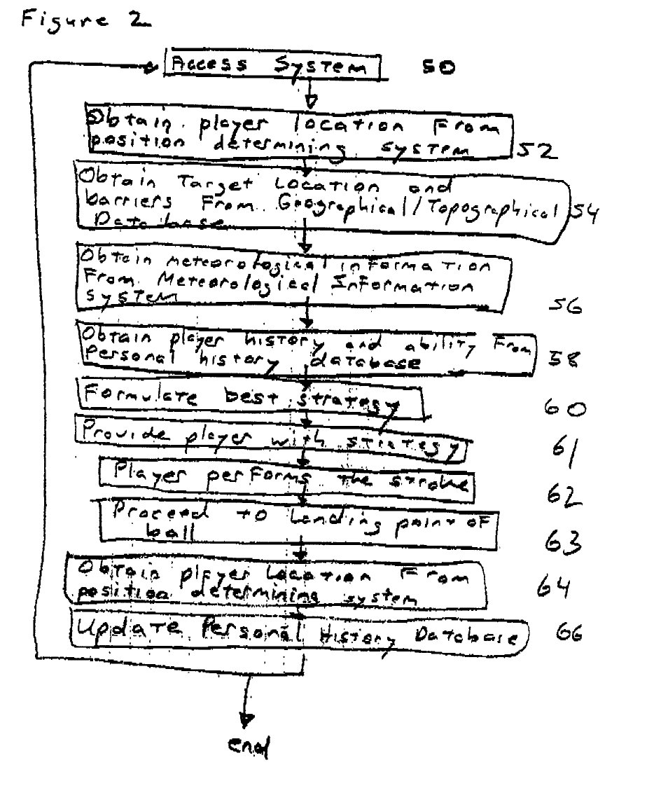

The present invention is a system for advising and instructing a user performing an activity. The principles and operation of systems according to the present invention may be better understood with reference to the figures and the accompanying description. For clarity, in the description below and with reference to FIG. 1 and FIG. 2, a specific non-limiting embodiment of the system according to the invention will be described in the context of providing strategy to a user who is playing a game of golf.

FIG. 1 shows a system 10 according to the present invention. The system 10 includes two databases. A first database 12 contains geographical and topographical data that is important to performance of the activity. A second database 14 contains data relating to the skill and ability of the user in performing the activity, including such parameters as strength or coordination, expressed in terms that are applicable to the activity. The system 10 also includes a meteorological information system 16, which provides information about the meteorological parameters that influence the activity. Furthermore, system 10 has a position determining system 18 that provides information concerning the location of the user at the moment when a request for assistance is made. Based on information from data bases 12 and 14, from meteorological information system 16, and from positioning determining system 18, processor 20 determines advice as to the preferred course of action, and provides this advice to the user through a display system 22.

The databases 12 and 14, the meteorological information system 16 and the positioning determining system 18 are all described more in detail hereinbelow.

It is clear that for any given activity, a method must be available that yields advice based on the information from databases 12 and 14, the meteorological information system 16 and the positioning determining system 18. For golf, methods to calculate the effect of factors such as player skill, terrain and meteorological conditions are well known in the art and are often integrated into entertainment products, see for example “Golf Fore!” (Incredible Technologies, Rolling Meadows, Ill.) or “Golf 2001” (Microsoft, Seattle, Wash.).

As mentioned above, a specific non-limiting embodiment of system 10 according to the invention configured to provide strategy to a user who is playing a game of golf is described hereinbelow with reference to FIG. 1. The first database 12 contains the geographical and topographical layout of the golf course. The second database 14 contains personal data concerning the skill and ability of the user, such as what distance and with what accuracy the user can strike a golf ball using a specific golf club under given conditions. Meteorological information system 16 provides salient meteorological data such as wind-speed and direction on the golf course.

The flow chart in FIG. 2 will now be described in the context of golf, although as mentioned above, the invention has various other applications. When the user is in need of advice, the user accesses the system in step 50. The processor 20 ascertains the position of the user in step 52 by consulting the position determining system 18. In the golf application, this position would be the position from which the ball is to be struck. The processor 20 then consults the geographical and topographical database 12 so as to obtain the final target for the stroke (for example, the hole or the green), as well as any obstacles and barriers separating the user's present position from the target in step 54. The processor 20 then obtains the relevant meteorological data from the meteorological information system 16 in step 56. In addition, processor 20 obtains information of the user's abilities and the user's past performance from the personal history database 18 in step 58. Based on the information from databases 12, 14, and the meteorological and position determining systems 16 and 18, processor 20 formulates, in step 60, a strategy to the user. For example, the strategy may be whether to attempt a shot onto the green or to lay-up near the green to avoid a bunker or other obstacle, what type of stroke to use, which golf club to use, and/or which direction to aim. The processor 20 then displays the strategy to the user via the display system 22 in step 61.

According to one embodiment of the present invention, display system 22 is a portable device such as a cellular phone or personal digital assistant configured to relay the strategy from processor 20, or is integrated with the same. In another embodiment of the invention, the strategy is relayed using a cellular telephone system by voice communications, SMS or WAP. In another embodiment of the invention, the strategy is relayed using Bluetooth-enabled technology. In yet another embodiment of the present invention, display system 22 is a dedicated wireless device configured to receive instructions from processor 20.

The content of geographical and topographical database 12 preferably includes the geographical and topographical information relevant to the activity performed including locations of the tees, greens, holes, bunkers and other obstacles as well as line of sight information. Although in principle this data needs to be collected only once, changes in the golf course may necessitate regular updating of the database. This database is preferably maintained by individuals connected with the golf course and can be updated regularly to reflect changes such as green hardness or hole location. It will be appreciated that the growing use of GIS (Geographical Information Systems), as well as digital design of landscapes, using CAD (Computer Aided Design) tools will enable relatively easy insertion of relevant topographical and geographical information. Alternatively, the user may be allowed to input changes to database 12, such as the present conditions of the greens, using the portable device.

In one embodiment of the invention, geographical and topographical database 12 resides in the portable device. This may be done using replaceable physical media (e.g. diskette or flash card). In another embodiment, database 12 is stored using a virtual media in the portable device at the beginning of the activity from a central location through wireless or physical connection. In a preferred embodiment database 12 is stored at a location remote from the portable device and is consulted interactively through a wireless connection, such as a portable Internet access device, cellular telephone network, or Bluetooth-enabled technology. For example, the database 12 is established and maintained on a daily basis by the golf-course operator and stored on the golf-course server.

The content of personal information database 14 may include general skill information such as accuracy vs. strength or endurance (the influence of distances walked and length of the game) as well as performance using a specific golf club. Database 14 is preferably history-based: the results of performance of a stroke under specific conditions is registered and analyzed to yield factors such as strength and accuracy, in a manner analogous to that done by a golf-pro. The content may also include more specific information such as where a golf ball landed after being struck by the user, and under what conditions and with what club. The content may also include information concerning player performance at a specific golf-course.

When database 14 is history-based, the portable device may be configured to automatically update personal information database 14, accepting the results of a user's action and effecting storage of these results in personal history database 14 or, alternatively, the portable device may be configured to allow the user to manually input the result of each stroke into the personal history database 14.

In one embodiment of the invention, personal information database 14 resides in the portable device as an integral part of the system. This may be done using replaceable physical media. In another embodiment database 14 is accessed using virtual media at the beginning of the game from a central location through a wireless or physical connection. For example, database 14 may be accessed at a location remote from the portable device and is consulted interactively through a wireless connection, such as wireless Internet, cellular telephone network, or Bluetooth-enabled technology. For example, database 14 is stored at the website of the player or at the clubhouse.

The data supplied by the meteorological information system 16 preferably includes all salient meteorological data such as humidity, precipitation and the presence of wind. In one embodiment of the invention, the relevant meteorological data is supplied to meteorological information system 16 manually by the user with the help of the portable device. This may be performed with a simple menu where the player must choose between such conditions as “dry”, “humid”, “rainy”, “wind from the East” or “Temperature=25°”. In another embodiment of the invention, relevant data from meteorological information system 16 is stored in the portable device, using virtual media at the beginning of the activity from a central location through a wireless or physical connection. In another embodiment data from meteorological information system 16 is stored at a location remote from the portable device and is consulted interactively through a wireless connection, such as wireless internet, cellular telephone network, or Bluetooth-enabled technology. For example, meteorological information system 16 may be manually updated by individuals connected with the golf course and can be updated regularly to reflect changes such as temperature, rain intensity or wind speed and direction, found by direct observation or by consulting weather reports. Preferably, meteorological information system 16 includes a system of sensors in and around the golf course which transmit real-time relevant meteorological information to the golf-course server. It is clear to one skilled in the art that the more the meteorological information supplied to processor 20 is detailed, the better the quality of the advised strategy.

In one embodiment of the present invention, position-determining system 18 receives signals from an earth orbiting satellite-positioning system, such as the GPS or GLONASS. For example, the portable device contains a receiver to receive signals from an earth-orbiting satellite positioning system and is configured to calculate the position of the user from the received signals. The position of the user is then automatically supplied to processor 20.

Since in an activity such as golf the accuracy of position determination is preferably in the order of tens of centimeters, the accuracy of current commercial (non-military) satellite based positioning systems may not be sufficient. Further, more sensitive and accurate satellite based positioning systems may be price prohibitive. Therefore, in another embodiment of the invention, position-determining system 18 is a local positioning system that includes a tracer device carried by the user. The tracer device includes a transmitter, for instance, integrated into the portable device. A plurality of receivers are provided at disparate respective geographical locations and are configured to receive signals as relative geographical data from the tracer. The processor 20 then calculates the location of the tracer relative to the receivers and consequently the location of the user. For example, processor 20 can calculate the location of the tracer by triangulation, based on different arrival times of a tracer signal at the various receivers. The tracer device may be, for example a cellular telephone or a personal digital assistance with wireless communication ability and the transmissions from the cellular telephone or the personal digital assistant are used by a local positioning system, as described above, to ascertain the user's position.

In another embodiment, the portable device is a cellular telephone, and the standard cellular telephone network is used to calculate the location of the user as an integral part of the position determining system 18. Methods for ascertaining the location of a cellular telephone using a cellular telephone network are well known in the art, see, for example, U.S. Pat. No. 5,844,522 or U.S. Pat. No. 6,163,701

In an additional embodiment of the invention, the user with the help of the portable device manually supplies position information to position determining system 18.

As mentioned above, in one embodiment of the present invention the portable device is configured to automatically accept the results of a user's action and effect storage of these results in personal history database 14. After the user has followed the strategy provided by the system in step 62 and the ball is again at rest, the user stands near the ball in step 63. The location of the user and consequently the ball is found by the position determining system 18 in step 64. Alternatively, the user manually inputs the result of each stroke into the personal history database 14. This new position is recorded in the personal history database 14 in step 66 as the result of following the strategy advised in step 62.

In an additional embodiment of the present invention, processor 20 is configured to identify a significant discrepancy in player performance during a specific game and modify the advised strategy. For example, processor 20 identifies that on a given day the first two holes have been played with less accuracy or strength than usual (relative to historical data stored in personal history database 14). Processor 20 can then advise strategy that is based on the weakened state of the player for that specific day.

The system of the invention may be applied to a large variety of human activities. Besides golf, the system with appropriate modifications that will be apparent to those skilled in the art, can be used by persons engaging in other sports such as sailing, fishing or baseball, as well as other activities.

While the invention has been described with respect to a limited number of embodiments, it will be appreciated that many variations, modifications and other applications of the invention may be made, without exceeding the scope of the invention.

What is claimed is:

1. A system for providing a strategy to a user performing an activity, comprising:
a) a geographical and topographical database configured to store geographical and topographical information related to the activity;
b) a locating mechanism for determining a location of the user; and
c) a processor, coupled to said first database and to said locating mechanism, for receiving stored geographical and topographical information and information related to the user's location, said processor operable for providing a strategy to the user based on the geographical and topographical information, and said user location information.

2. The system of claim 1, further comprising a meteorological reporting mechanism for gathering meteorological information related to performance of the activity, and wherein said processor is further operative to provide the strategy to the user based on said meteorological information.

3. The system of claim 1, further comprising a historical database configured to store historical information related to a past performance of the activity by the user, and wherein said processor is further operative to provide the strategy to the user based on said historical information.

4. The system of claim 2, further comprising a historical database configured to store historical information related to a past performance of the activity by the user, and wherein said processor is further operative to provide the strategy to the user based on said historical information.

5. The system of claim 1, further comprising a display mechanism to display said strategy to the user.

6. The system of claim 5, wherein said display mechanism is portable and configured to accompany the user during performance of the activity.

7. The system of claim 6, wherein said display mechanism is a cellular telephone.

8. The system of claim 6, wherein said display mechanism is a personal digital assistant.

9. The system of claim 1, wherein said locating mechanism includes a satellite positioning system receiver.

10. The system of claim 1, wherein said locating mechanism includes:
i) a tracer configured to accompany the user during performance of the activity and to transmit a signal; and
ii) a plurality of receivers located at disparate geographical locations, and configured to receive said signal.

11. The system of claim 10, wherein said tracer is a cellular telephone.

12. The system of claim 1, wherein said display mechanism is a personal digital assistant, and wherein said tracer is integrated into said personal digital assistant.

13. The system of claim 10, wherein said processor is operative to calculate a location of said tracer from said received signal.

14. The system of claim 10, further comprising a second processor operative to calculate a location of said tracer from said received signal.

15. The system of claim 1, wherein said locating mechanism includes:
i) a plurality of transmitters located at disparate geographical locations, each of said transmitters configured to transmit a different signal; and
ii) a tracer configured to accompany the person during performance of the activity and to receive the different signals from said transmitters.

16. The system of claim 15, wherein said processor is operative to a location of said tracer from said signals.

17. The system of claim 15, further comprising a second processor operative to calculate a location of said tracer from said signals.

18. The system of claim 1, wherein said strategy is an instruction concerning how to proceed in a sport.

19. The system of claim 18, wherein said sport is golf.

20. The system of claim 19, wherein said geographical and topographical database stores geographical and topographical information relating to a golf course.

21. The system of claim 19, wherein the strategy provided by said processor concerns which golf club to select.

22. The system of claim 19, wherein the strategy provided by said processor concerns how to strike a golf ball.

23. The system of claim 22, wherein the strategy includes which golf club to select.

24. The system of claim 2, wherein the strategy is an instruction concerning how to proceed in playing golf.

25. The system of claim 24, wherein said meteorological reporting mechanism gathers information relating to at least one of wind conditions, precipitation and temperature of a golf course.

26. The system of claim 3, wherein said strategy is an instruction concerning how to proceed in playing golf, wherein said historical database stores historical information as to how the user played on a golf course.

27. The system of claim 26, wherein information concerning each stroke by the user on the golf course is stored in said historical database.

28. The system of claim 27, wherein the information stored in said historical database includes the club used by the user for each stroke on the golf course.

29. The system of claim 4, wherein said strategy is an instruction concerning how to proceed in playing golf, wherein said geographical and topographical database stores geographical and topographical information relating to a golf course, and said meteorological reporting mechanism gathers meteorological information about said golf course.

30. A method of improving a performance by a user engaged in playing a sport, comprising:
a) electronically storing geographical and topographical information relating to performance of the sport;
b) determining a physical location of the user; and
c) recommending a strategy to the user concerning performance of the sport based on said geographical and topographical information and the user's physical location.

31. The method of claim 30, further comprising supplying meteorological information related to the sport, wherein the recommended strategy is also based on said meteorological information.

32. The method of claim 30, further comprising electronically storing historical information related to a past performance of the sport by the user, and wherein the recommended strategy is also based on said historical information.

33. The method of claim 31, further comprising electronically storing historical information related to a past performance of the sport by the user, and wherein the recommended strategy is also based on said historical information.

34. The method of claim 30, wherein said recommended strategy includes selection of a golf club.

35. The method of claim 30, wherein said recommended strategy includes information concerning how to strike a golf ball with a golf club.

36. The method of claim 34, wherein said recommended strategy includes information concerning how to strike a golf ball with a golf club.

37. The method of claim 30, wherein said stored geographical and topographical information relates to geographical and topographical information of a golf course.

38. A method of improving a performance by a user engaged in playing golf, comprising:
a) electronically storing geographical and topographical information relating to a golf course;
b) determining a physical location of the user on the golf course;
c) supplying meteorological information relating to the golf course;
d) electronically storing historical information related to a past performance by the user on the golf course; and
e) recommending a strategy to the user concerning how to strike a golf ball in accordance with the geographical and topographical information, the user's physical location, the meteorological information, and the historical information.

39. The method of claim 38, wherein the recommended strategy includes information concerning which golf club to select.

40. The method of claim 38, wherein the recommended strategy includes whether to hit for the green.
